(19) United States
(12) Patent Application Publication
(10) Pub. No.: US 2024/0365874 A1
(43) Pub. Date: Nov. 7, 2024

(54) Aerosol Generating Device Comprising an Optical Sensor

(71) Applicant: JT International SA, Geneva (CH)

(72) Inventor: Patrick Debergh, cressier (CH)

(73) Assignee: JT International SA, Geneva (CH)

(21) Appl. No.: 18/686,271

(22) PCT Filed: Aug. 19, 2022
(86) PCT No.: PCT/EP2022/073243

§ 371 Date: Feb. 23, 2024

(30) Foreign Application Priority Data
Aug. 26, 2021 (EP) 21193354.4

(51) Int. Cl. A24F 40/51; A24F 40/42; G01J 1/04

(52) U.S. Cl. CPC A24F 40/51; A24F 40/42; G01J 1/0437

(57) ABSTRACT

A smoking device (2) comprises an optical sensing system (5) for reading indicia (10) on a consumable article (1). Means are provided for adapting a characteristic of the optical sensing system (5) in response to a distance of the indicia (10) from the optical sensing system (5). The adapting means may change the focal length of an optical clement (120) by applying a potential difference to change a refractive index of the optical element (120) or to change the curvature of an optical surface (130). The optical surface (130) may be an interface between two immiscible liquids (122, 124) that have different electrical properties. The adapting means may alternatively move an element of the optical sensing system (5) in response to the distance of the indicia (10), for example by changing a shape of a support of an optical element (120). The optical element may comprise a pinhole (20) and the adapting means may change the size of its aperture.

### TECHNICAL FIELD

The present disclosure relates generally to an aerosol generating device for generating an aerosol for inhalation by a user. Embodiments of the present disclosure also relate to an aerosol generating system comprising an aerosol generating device and a replaceable or consumable article, which contains a substance that is vaporized to generate the aerosol. The aerosol generating device is generally a hand-held device for receiving the consumable article. The consumable article may comprise an aerosol generating substrate, e.g., tobacco or other suitable materials, which the aerosol generating device heats, rather than burns, to generate the aerosol. Alternatively, the consumable article may comprise a reservoir of a liquid, which is vaporized in the aerosol generating device to generate the aerosol. The consumable article may carry indicia that identify characteristics of the article. The present invention relates to an optical reader for reading such indica on a consumable article that is received in the aerosol generating device.

### BACKGROUND OF THE INVENTION

The popularity and use of reduced-risk or modified-risk devices (also known as aerosol generating devices, vapour generating devices or smoking devices) has grown rapidly in recent years as an alternative to the use of traditional tobacco products. Various electrically powered devices and systems are available that heat or warm aerosol generating substances to generate an aerosol for inhalation by a user.

A commonly available reduced-risk or modified-risk device is the heated substrate aerosol generating device, or so-called heat-not-burn (“HNB”) device. Devices of this type generate an aerosol or vapour by heating an aerosol generating substrate. The HNB system's working principle is to heat a tobacco material comprising an aerosol-forming substance (such as glycerine and/or propylene glycol) which vaporises during heating. The substrate is usually heated at between 200 and 400° C., which is below the normal burning temperatures of a conventional cigarette. Heating the aerosol generating substrate to a temperature within this range, without burning or combusting the aerosol generating substrate, generates a vapour that extracts nicotine and flavour components from the tobacco in the substrate then typically cools and condenses to form an aerosol for inhalation by a user of the device. In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

The aerosol generating substrate may be packaged in a consumable article that is somewhat similar to a conventional cigarette. An air path extends from a distal end of the article to a proximal end of the article, passing through at least the aerosol generating substrate and optionally through other elements such as a condensing chamber and one or more filters. Such articles may be generally cylindrical in shape with a paper wrapper that forms the circumferential outer surface, while allowing air to flow into the article through the distal end and to flow out of the article through the proximal end. Shapes other than cylinders are known: for example, the consumable article may have a flattened, rectangular, card-like shape.

The distal end of the article may be received in a heating chamber of the aerosol generating device. The aerosol generating device comprises a heater, which is configured to apply heat to the article in the heating chamber by conduction, radiation and/or convection to cause the substrate to be heated to the desired temperature without burning. The proximal end of the article may be received in the mouth of a user, who can inhale to draw air through the article. As air is drawn through the heated substrate, nicotine and/or other volatile substances in the substrate are vaporized to enter the airstream and subsequently condense to form an aerosol for inhalation by the user. At the end of a smoking session, or when the level of volatile substances in the aerosol generating substrate has fallen below an acceptable level, the aerosol generating article may be removed from the heating chamber, to be replaced subsequently by a new article.

An alternative type of aerosol generating device comprises an airflow path from an air inlet, through a heating chamber, to an air outlet at a mouthpiece. The mouthpiece of the article may be received in the mouth of a user, who can inhale to draw air along the airflow path through the heating chamber. An aerosol generating liquid is gradually introduced into the heating chamber, for example via a wick. The aerosol generating device comprises a heater for increasing the temperature in the heating chamber, whereby the aerosol generating liquid vaporizes, enters the airstream and subsequently condenses to form an aerosol for inhalation by the user.

The aerosol generating liquid is supplied to the heating chamber from a liquid reservoir or tank. The reservoir may be provided in a consumable article in the form of a cartridge, whereby one cartridge may be removed from the device, to be subsequently replaced by another cartridge in order to refresh the supply of liquid if it has become exhausted or to exchange the liquid for one with different characteristics if desired.

A consumable article for either type of aerosol generating device may bear a code or other optically readable indicia, which identify characteristics of the article, such as the flavour or strength of the aerosol generating substrate or liquid it contains, or physical characteristics that may determine how the article should be used. A “smart” aerosol generating device may comprise an optical reader, which can read the indicia on consumable articles that are introduced therein. A controller in the device may then respond appropriately to the characteristics of the article, for example by operating the heater at a different temperature or for a different duration, by displaying information to the user of the device; and/or by disabling operation of the heater if the characteristics of the consumable article make it unsuitable for use in that device or by a user registered to that device. Operation of the device may also be disabled if the consumable article is identified as counterfeit by the absence of a required authentication code being detected within the indicia.

Imaging of indicia may be performed through lenses or mirrors provided in the aerosol generating device. Published patent application US 2019/0008206 A1 discloses a smoking article comprising an indicium on its outer surface, which represents the type of smoking article and may be in the form of pattern such as a one-or two-dimensional barcode. The indicium includes different grey levels that can be generated by printing in dots which have smaller size. The proposed optical sensing mechanism requires imaging lenses or mirrors in order to read the indicium.

It is difficult to arrange optical elements such as lenses and mirrors in the very small space that is available alongside a consumable article when received in the device, given that such elements may need to be spaced at a suitable distance from the indicia, the distance being related to their focal length. Furthermore, during use of the device, the optical elements may be exposed to temperatures higher than 100° C. or even higher than 200° C., which limits considerably the choice of materials. Depending on the materials used, such as transparent plastics, there is an issue of their long-term stability. Also, lenses and mirrors have to be aligned and adapted in holders, which increases the number of components and the associated assembly costs of the device. Residues from the volatile substances may build up in the device or on the optical elements themselves and there is a risk that the optical elements may be scratched or damaged by the use of cleaning brushes.

Because of the limited space available, very small optical elements with a short focal length are typically used to image the indicia. For example, a micro-optical imager may have a total length of only 0.5 to 2 mm. The present inventor has recognized that such small elements may be particularly sensitive to variations in the distance between the wrapper of an article and the optical system, for example because of irregularities in the surface of the article or a departure of the shape or diameter of the article from expected values. Such variations may result in the indicia appearing out of focus or suffering a loss of contrast and may limit the ability of the optical system to read the indicia reliably.

It is desirable that imaging systems for use in aerosol generating devices should be simple, robust and cheap, therefore it is desirable that the number of components and mechanically moving parts should be kept to a minimum.

### SUMMARY OF THE INVENTION

According to the present invention, a smoking device comprises a housing having a cavity for at least partially receiving the consumable article; an optical sensing system that is configured to read indicia on a consumable article received in the cavity; and adapting means for adapting a characteristic of the optical sensing system in response to a distance of the indicia from the optical sensing system. By adapting a characteristic of the optical sensing system in response to its distance from the indicia, the focus and/or contrast of the indicia as perceived by the optical sensing system can be maintained or improved. This allows the system to read the indicia more reliably. Alternatively, it allows information to be coded more densely in the indicia without increasing the error rate when the indicia are read by the optical sensing system.

In some embodiments of the invention, the optical sensing system comprises an optical element having a focal length and the adapting means is configured to adapt the focal length of the optical element in response to a distance of the indicia from the optical sensing system. Such an optical element may comprise at least one lens or mirror. Adapting the focal length of the optical element may avoid or reduce the need to physically move the entire optical element, image detector or optical sensing system in order to bring the indicia into focus. This may avoid the need to provide space to accommodate such movement and/or means for supporting the optical element as it moves and/or an actuator to effect such movement.

Preferably the optical element comprises an optical surface and the adapting means is configured to adapt the focal length of the optical element by changing a curvature of the optical surface. The optical surface could be the surface of a lens, where light emitted by the indicia is refracted, or the surface or a mirror, where light emitted by the indicia is reflected. There are various ways of changing the curvature of the surface while the optical element as a whole remains fixed in place.

For example, the optical element may comprise two immiscible liquids, the optical surface being formed at an interface between the two liquids; the smoking device further comprising an electrical circuit for applying a potential difference between the two liquids, wherein the adapting means is configured to change the curvature of the optical surface by changing the potential difference between the two liquids. This example gives rise to the advantage that it does not require any mechanically moving parts: the movement of the optical surface is achieved by purely electrical means, which are easy to accommodate and to control in a typical smoking device. In such an example, one of the liquids may be a polar liquid and the other of the liquids may be a substantially non-polar liquid. Additionally or alternatively, one of the liquids may be electrically conductive and the other of the liquids may be substantially electrically non-conductive. In either case, changing the potential difference between the two liquids will alter the distribution or concentration of electrical charges on opposite sides of the optical surface between them. This in turn causes the surface to change shape to achieve the lowest available surface energy. Preferably, the two liquids are translucent to a wavelength of light that the optical sensing system is capable of detecting and the two liquids have different refractive indices, whereby the optical element can serve as a variable focus lens.

In another example, the optical element comprises a body of liquid in contact with a substrate, the optical surface being an interface between a surface of the liquid that is not in contact with the substrate and a gas, and the device further comprises a circuit for applying a potential difference between the liquid and the substrate, wherein the adapting means is configured to change the curvature of the optical surface by changing the potential difference between the liquid and the substrate. The gas may be air from the surrounding atmosphere or an alternative gas combined within a sealed chamber. As in the previous example, changing the potential difference between the liquid and the surface will alter the distribution or concentration of electrical charges in the liquid. This in turn causes the optical surface to change shape to achieve the lowest available surface energy, for example by changing the contact angle between the body of liquid and the surface. Preferably, the liquid is translucent to a wavelength of light that the optical sensing system is capable of detecting, whereby the optical element can serve as a variable focus lens. The substrate may be translucent or it may be reflective to return the light through the optical surface a second time. If the substrate is reflective, it may also be curved to act as a concave mirror.

In a further example, the optical element comprises a body of liquid, the optical surface being a surface of the liquid, and the adapting means is configured to change the curvature of the optical surface by changing the quantity of liquid in the body. Most simply, the body of liquid may be a drop of the liquid, in which the curvature of the drop's surface decreases as the drop grows or increases as the drop shrinks. The body of liquid may be contained by a membrane and/or supported by a substrate. This approach has the advantage that it does not require the liquid to have any special optical or electrical properties, other than being translucent to permit light to pass through the optical surface. The quantity of liquid in the body may be changed by pumping liquid into or out of it from a reservoir of the liquid, for example by the use of a plunger. Alternatively, the optical element may further comprise a heater controllable to change the temperature of the liquid in the reservoir, whereby liquid can be displaced from the reservoir towards the body of liquid by thermal expansion of the liquid in the reservoir. The body of liquid may be contained within a cell comprising a resilient membrane that defines the optical surface.

In other embodiments of a smoking device according to the invention, the optical element is a lens and the device further comprises a circuit for applying a potential difference across the lens, wherein the adapting means is configured to adapt the focal length of the optical element by changing the potential difference across the lens to change the refractive index of the lens. In certain materials, the Kerr effect and/or the Pockels effect causes the material to become birefringent in response to an applied electric field, such that its refractive index is different when measured parallel to or perpendicular to the field. In the present embodiment, by making the lens from a suitable material and by suitably choosing the direction of the applied potential difference relative to the optical axis of the lens, the focal length of the lens can be changed by purely electrical means, without the need for any mechanically moving parts.

In other embodiments of the invention, the adapting means is configured to move at least one element of the optical sensing system to adapt the position of the element or the optical sensing system in response to a distance of the indicia from the optical sensing system. In these embodiments, at least an element of the optical sensing system, or the entire system, is physically moved to enhance its ability to read the indicia. A mechanical system may be more robust and durable than one involving liquids, for example, and permits the use of conventional optical elements. There are various ways of performing such mechanical movement within the constraints of space and complexity that a smoking device imposes.

The adapting means may be configured to maintain the element or the optical sensing system at a predetermined distance from the indicia. For example, the focal point of the optical sensing system element may be at the predetermined distance from an object lens or concave mirror of the system, whereby the invention allows the focal point to be moved such that it remains coincident with the indicia and the optical sensing system maintains a clearly focused view of the indicia.

Alternatively, the elements of the optical sensing system may comprise an optical element and an image detector, wherein the adapting means is configured to move the optical element relative to the image detector in response to a distance of the indicia from the optical sensing system. In this example, either the optical element or the image detector (or both) may be moved but such movement is internal to the optical sensing system. In general, the entire optical sensing system does not need to be moved so the housing of the smoking device does not need to contain space to accommodate such movement. For example, the configuration of the optical sensing system may be such that an image of the indicia will remain focused on the image detector provided that a first distance from the indicia to the lens and a second distance from the lens to the image detector remain in a predetermined ratio. If the total distance between the indicia and the image detector changes, then the optical element and/or the image detector can be moved in such a way as to maintain the predetermined ratio between the first and second distances.

The optical element may be formed in or mounted on a support element and the adapting means may be configured to move the optical element relative to the image detector by changing a shape of the support element. While the shape of the support element changes, it continues to provide the required support so the optical element is not “floating”. The shape of the support element may constrain its freedom of movement, whereby further means are not required to guide the movement of the optical element. Preferably the support element moves by bending or flexing, which can be driven by non-mechanical means such as heating, electrostatic or electromagnetic.

The optical element may be formed in or mounted on a central plate, wherein the distance of the central plate from the indicia is controlled using electric charges. For example, there may be provided at least one charge plate generally parallel to the central plate; and means for controlling the electrical charge on the charge plate in order to attract or repel the central plate. The central plate may be supported on a resilient support element. Thus the central plate is not “floating” and continues to be supported when no power is applied. The resilient support element may also provide a restoring force to balance the forces applied using the electric charges.

The optical element may comprise a pinhole formed in the support, which has the advantage of being simple to manufacture, as well as being robust and durable in use. A pinhole is typically able to function in a high temperature environment.

The invention thereby provides an aerosol generating device that comprises a variable focus micro-optic imager that should be able to cope with a variable distance of the surface of an article relative to the imaging component of an imager.

The adaptive focusing element also allows the focal point to be varied to retrieve depth information on for example indicia that have a dimension in the direction orthogonal to the surface of a wrapper. For some optical frequencies such as infrared or terahertz waves, the focuser could focus an image of a portion of an area or volume that is arranged inside an article. Also, by adding an additional lateral movement, by using for example a micro-piezo driver, the focusing system could be adapted to retrieve 3D information of indicia or other features of an aerosol-generating article.

In some embodiments, the optical sensing system may further comprise a light source, preferably positioned close to the optical element on a side facing the consumable article. For example, the light source may directly illuminate the indicia of the consumable article, or a reflecting element may be used to reflect the light of the light source towards the indicia of the consumable article. A clearer image can thus be produced.

In some embodiments, the optical sensing system comprises an integrated heater to provide a light source for the purpose of illumination. For example, the integrated heater may provide a source of infrared light.

According to yet another embodiment, at least two optical elements are provided at different axial positions and/or longitudinal positions. For instance, when the optical elements are provided at different axial and/or longitudinal positions, the respective images formed by them on the image plane may be at least partially overlapped such that a wider image can be formed on the image plane to be detected by the image detector.

According to yet another embodiment, the at least two optical elements are provided at the same axial position or longitudinal position. For instance, when the at least two optical elements are provided at the same axial position, it can be used to increase the sensitivity of the optical sensing system or allows more information on the indicia to be detected by the optical sensing system. For instance, indicia are provided circumferentially around a consumable article, hence the indicia may have the same coded information on two opposing sides. Then two optical elements provided opposite to each other allow two identical images to be formed on respective image planes and subsequently detected by the image detector(s). The information from the two images can be processed and compared to ensure that the information is correctly read. If indicia are not provided around the whole circumference of a consumable article, then providing multiple optical elements may make the optical sensing system more sensitive to consumable articles that are inserted into the cavity in different orientations.

According to some embodiments, an array of optical elements is provided parallel to the cavity axis. This array of pinholes may contain from two to ten optical elements, which may be provided close to each other, and the images formed on the image plane may be at least partially overlapped or may not be overlapped with each other.

According to some embodiments, the images on the image plane detectable by the image detector are at least partially overlapped or are not overlapped. When the images are partially overlapped, it has the advantage that the accuracy of the optical sensing system is increased as well as that a wider image can be detected.

In some embodiments, one or more adaptable pinholes are provided in the form of slits parallel to the cavity axis. This allows for instance information from different parts of the indicia of the consumable article to be detected by the optical sensing system, in particular information that is presented along essentially one dimension in the indicia, such as a linear barcode that extends around the circumference of a consumable article.

In some further variants, one or more optical elements are provided in between the pinhole and the image plane. This advantageously increase the sensitivity and accuracy of the optical sensing system of the present invention.

According to some variants of the invention, the optical sensing system comprises one or more field lenses between a pinhole and the image detector to provide an enlarged field of view. This has the advantage that there is less error in focusing distance for instance when using a ‘focus and recompose’ technique in the optical sensing system.

In some further variants, the adapting means is configured to adapt a size of the pinhole in response to a distance of the indicia from the optical sensing system to allow a clearer or more accurate image to be formed.

In some variants of the embodiments, the size of the pinhole is adjustable through electromagnetic or electrostatic means or through two MEMS blades, each having a half-circular aperture.

As used herein, the term “aerosol-generating material” refers to a material capable of releasing volatile compounds upon heating, which can form an aerosol. The aerosol generated from aerosol-generating material may be visible or invisible and may include vapours (for example, fine particles of substances, which are in a gaseous state, that are ordinarily liquid or solid at room temperature) as well as gases and liquid droplets of condensed vapours.

The term “indicia” (plural) or “indicium” (singular) is defined as elements or a structure containing information about a consumable article and is typically arranged on a surface of an article. The surface may be an outer or an inner surface of an article such as a surface pertaining to a wrapper of the article. An indicium may be embedded inside the article if the device is configured to illuminate the article with light of a wavelength that can penetrate the surface and the optical sensing system is capable of detecting reflected light of that wavelength. If the indicia form part of an anti-counterfeiting measure, this may make them more difficult to copy.

As used herein the term “pinhole” refers to a pinhole aperture. The hole is very small (e.g. ranging typically from 5 μm to 500 μm, preferably between 10 μm and 100 μm) and may be made traditionally by, for example, a pin or realized by microtechnologies. The optical system comprising a pinhole is effectively a light-proof box with a small hole in one side. Light from a scene passes through the aperture and projects an inverted image on the opposite side of the box, which is known as the camera obscura effect. The advantages of pinholes are their depth of focus. Everything in an image taken by a pinhole in an optical sensing system is in focus according to a relation between the distance of the object to the pinhole and the distance of the pinhole to the image plane. A pinhole system is very simple, easy to make and to use. Ideally, the pinhole is provided having a typical aperture of between about 20 μm and 200 μm, more preferably between about 25 μm and 100 μm such that a sharp and a clear image can be formed on the image plane to be detected by the image detector of the optical sensing system.

In relation to a lens, mirror or combination of such elements in an optical sensing system, the term “focal length” is used herein in its conventional sense, namely, in the case of a converging lens or mirror, the distance from the element at which parallel incident light rays are brought to a focus. By analogy, in this specification the “focal length” of a pinhole of an optical sensing system means the distance from the hole to the image plane. For instance, a 0.3 mm chemically etched pinhole may provide an approximate aperture of f/2 to f/100, depending on the involved distances, and a magnetic locking shutter may further be provided to allow for controlled exposures.

The term “light” is not limited to visible wavelengths of light; it includes electromagnetic radiation of other wavelengths in the infrared and ultraviolet ranges that are compatible with the scale and function of the optical sensing system.

In this specification, “upper”, “lower” and similar terms indicating orientation are used only for convenience with reference to the embodiments of the invention illustrated in the drawings. It will be understood that devices according to the invention may be manufactured, transported, stored and used in any orientation, while still falling within the scope of the claims.

By “about” or “substantially” or “approximately” in relation to a given numerical value, it is meant to include numerical values within 10% of the specified value. All values given in the present disclosure are to be understood to be complemented by the word “about” unless it is clear to the contrary from the context.

The indefinite article “a” or “an” does not exclude a plurality, thus should be treated broadly.

For instance, the imaging may be realized by an optical system that has an object distance a from an indicium to a focusing system that is smaller than the image distance b between the focusing system and the image plane, i.e. b≥a wherein a and b are related by 1/f=1/a+1/b, f being the focal length of the focusing system of the optical reader of the device. It is generally understood that the image size need not necessarily be equal to the size of the detector that is used to detect the image. The detector may have, in at least one cross section, a size that is smaller or greater than the produced image.

### DRAWINGS

FIG. 1a shows a schematic representation of a smoking device comprising an optical sensing system in the form of a single pinhole imager, according to an embodiment of the present invention.

FIG. 1b shows an enlarged view of the optical sensing system shown in FIG. 1a.

FIG. 2 shows a schematic representation of a smoking device comprising two optical elements provided opposite to each other, according to another embodiment of the present invention.

FIG. 3 shows a schematic, perspective representation of a smoking device comprising an array of optical elements, according to a further embodiment of the present invention.

FIGS. 4a to 4d show schematic representations of different ways of adjusting the size of a pinhole according to some embodiments of the present invention.

FIG. 5 shows a schematic representation of a further way of adjusting the size of a pinhole according to some embodiments of the present invention.

FIG. 6 shows a schematic representation of an embodiment of the present invention, comprising an adaptable pinhole in combination with a lens.

FIG. 7a shows an adaptable optical sensing system in accordance with the invention, comprising a lens.

FIG. 7b shows an adaptable optical sensing system in accordance with the invention, comprising a mirror.

FIG. 8 shows a schematic representation of an embodiment of the present invention, comprising a transmitting optical element with a deformable interface between two non-miscible liquids.

FIG. 9 shows a schematic representation of an embodiment of the present invention, comprising a reflecting optical element with a deformable interface between two non-miscible liquids.

FIGS. 10a and 10b show schematic representations of an embodiment of the present invention, again comprising a reflecting optical element with a deformable interface between two non-miscible liquids.

FIG. 11 shows a schematic representation of an embodiment of the present invention, comprising a deformable interface at a surface of a body of liquid.

FIGS. 12a and 12b show schematic representations, respectively in plan and cross-section, of an embodiment of the present invention, comprising a deformable interface at a surface of a body of liquid contained by a membrane.

FIG. 13 shows a schematic, perspective representation of an embodiment of the present invention, again comprising a deformable interface at a surface of a body of liquid contained by a membrane.

FIG. 14 shows a schematic representation of an embodiment of the present invention, comprising an optical sensing system for reading one-dimensional indica.

FIGS. 15a and 15b show schematic representations of two variants of micro focusing arrays that may be used to image a 2D area.

FIG. 16 shows a schematic representation of an array of micro focusers according to the present invention arranged on a curved substrate.

FIG. 17 shows a schematic representation of an embodiment of the present invention, wherein the optical element is a pinhole.

FIG. 18 shows a schematic representation of an embodiment of the present invention, wherein the optical element is a pinhole.

FIG. 19 shows a schematic representation of an embodiment of the present invention, wherein the optical element is a pinhole.

### DETAILED DESCRIPTION OF THE INVENTION

The present invention will be described with respect to particular embodiments and with reference to the appended drawings, but the invention is not limited thereto. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

All the embodiments disclosed herein rely on adaptable micro-optical systems. Herein, the wording “adaptable system” or “adaptable element” means an optical system or optical element that is configured or comprises adapting means for adapting the characteristic of the optical sensing system. Adapting means may comprise means to modify the focal length and/or aperture and/or perform a displacement or vibration of the optical system or an optical element part of such system. The adaption of other optical parameters is also possible such as the variation of the state of polarisation and/or transmitted or reflected light intensities. The means are preferably configured to perform these adaptations at high speed, typically at a frequency higher than 10 Hz, preferably higher than 100 Hz, possibly higher than 1 kHz. It is also understood that an adaptable optical system may comprise elements that may be displaced or vibrated in the length of the cavity of a smoking device.

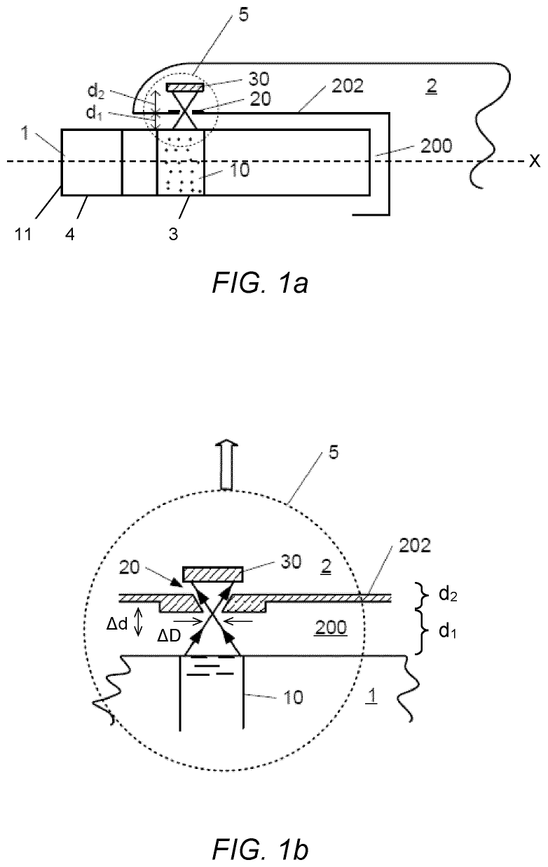

In an embodiment the optical microsystem relies on imaging by a pinhole. The use of a pinhole in an optical sensing system has the advantage that no lenses or curved mirrors are needed in the optical sensing system. Because of the small size and volume, and so very low mass, of a pinhole it can be displaced at a high speed. The same holds for changing its aperture as described further in the document. In a pinhole imaging system light is projected by pure geometric effects and the magnification factor is determined by the involved distances: as illustrated in FIG. 1, the magnification M=d₂/d₁, wherein d₁ is the object distance and d₂ is the image distance or “focal length”. M may be less than or equal to 1 or in the usual case may be greater than 1. The main disadvantage of a pinhole is that it allows little light to pass therethrough so the image formed tends to be dark. Nevertheless, the use of pinholes may be suitable for environments where a sufficient light source can be provided. Although a pinhole provides darker images than those provided by lenses or mirrors because of the small aperture of the pinhole, an image provided by a pinhole is usually sharp for chosen values of the object distance d₁ and the image distance d₂.

Several main parameters which may be crucial in a pinhole imaging are for instance:
(a) the distances from an object to the pinhole and from the pinhole to the image plane;
(b) the aperture of the pinhole, which typically may be between for example about 20 and 500 microns;
(c) the quality of the borders of the pinholes (that are in principle round-shaped pinholes)
(d) diffraction effects, which are related to the used wavelength and the roughness of the borders of the pinhole apertures.

Even though pinhole-based optical sensing systems are great and simple, that does however come with disadvantages in comparison with other optical sensing systems, such as lenses and mirrors. As the pinhole has a very small aperture which only allows a low amount of light to pass through the pinhole, the clarity of image may be an issue and a long exposure may be needed. However, for most of the indicia which may be provided on smoking articles such as aerosol-generating article, this usually does not pose as a big issue since the requirement for a high resolution and a clearer image is much lower. Moreover, the smoking article comprising an indicium provided thereon is inserted into the smoking device in a fixed position (not moving), hence there is time for a clearer image can be obtained and detected by the optical sensing system.

A blurred or unclear image may be produced in a pinhole-based optical sensing system through diffraction effects and/or the fact that the pinhole may have a rough border, as explained above. Therefore, the border should ideally be provided of a high quality. This can be achieved by for example forming the at least one pinhole of the optical sensing system from a chrome mask. The chrome mask may have two main types of base materials: soda lime glass which is comparatively inexpensive and/or synthetic quartz which has low thermal expansion and high optical transmittance. The chromium layer may be realized on any transparent surface, ideally of glass or Al₂O₃ (corundum or sapphire doped e.g. with titanium or iron).

As for the source of the light which is required in the present optical sensing system, an additional light source may be provided in the optical sensing system of the smoking device to supplement any ambient light. For example, pulsed light sources such as a pulsed LED or pulsed lasers (ultraviolet, visible, infrared) may be used. Furthermore, an image detector may be configured to perform synchronous detections so that very low average light intensities may be used and are still sufficient for the image detector to detect the image. It is sufficient that that peak power of the pulsed light is sufficiently high.

The optical performance of the pinhole image sensor may be largely influenced by diffraction effects. Therefore, precise holes have to be used. This can be achieved by providing high quality holes in a substrate that comprises a chrome mask, but other solutions may be used as pinholes in layers or substrates made of silicon (Si) or hard materials (SiO₂, quartz, synthetic diamond, Al₂O₃). Salt windows may also be used as a substrate, as they have a very wide spectral transmission. Salt windows or layers made from any combination of the first and last column of the periodic table (such as NaCl, NaBr, KCl, KI, CsBr, CsCl, CsI etc.) are commercially available and may have the best transmission in the mid-and far-infrared and have the largest spectral transparency, allowing to transmission of blue light as well as mid-/far-infrared light. One of the most preferred choices to make pinholes is to realize them in a chromium layer deposited on a SiO₂ window (or Si for wavelengths λ larger than 1.5 λm, above which silicon is transparent).

It is reiterated that the solution proposed according to the present invention can be provided with a low cost, provides a large design range, and allows images to be provided even though having the optical element (i.e. a pinhole) near to a very hot surface or providing the pinhole aperture on a heater surface. The optical imaging system according to this aspect of the present invention is especially suitable for low resolution indicia such as printed barcodes.

The invention will be described in the following examples in relation to aerosol-generating consumable articles 1 comprising a tobacco-containing charge of aerosol-generating material but the scope of the invention shall not be construed as limited only to the discussed tobacco-based consumable articles but shall encompass any aerosol-generating consumable articles, such as smoking articles, heat-not-burn articles, e-liquid cartridges and cartomizers, which comprise an aerosol-generating substrate capable of generating an inhalable aerosol upon heating. Aerosol-generating consumable articles 1 may or may not have a symmetry axis and may have any form or shape, such as an elongated, cylindrical, spherical, or the form of a beam.

As represented in FIGS. 1 to 3, aerosol-generating articles 1 may comprise at least a first portion 3 comprising an indicium 10 arranged on an outer surface and a second portion 4 attached to the first portion 3, which the second portion 4 may form a mouthpiece 11 for a user to inhale an aerosol generated upon heating of the first portion 3 after insertion of the consumable article 1 (e.g. aerosol-generating consumable article) in a heating cavity of an aerosol-generating device 2. The article 1 comprises a further portion which may not comprise an indicium 10. The indicium 10 may be arranged on one or both of the lateral sides of said further portion.

The invention is realized through a smoking device 2 (e.g. an aerosol-generating device). The invention is further realized by a system that comprises said smoking device 2 and a consumable article 1 that is inserted in said smoking device 2 through a cavity of the smoking device 2. The cavity is a receiving portion 202 of the smoking device 2 wherein at least a part of the consumable article 1 can be inserted. The receiving portion 202 of the smoking device 2 may be provided substantially parallel to the axis X of the housing of the smoking device 2. Nevertheless, it is disclosed herein that even when a consumable article 1 has been inserted in the cavity, a tiny gap 200 may still exist between the inserted consumable article 1 and the smoking device 2, as illustrated in FIG. 1a. An optical sensing system 5 of the smoking device 2 that is capable of detecting indicia 10 of a consumable article 1 is described in detail herein.

FIG. 1a shows a first embodiment of the invention, wherein an adaptable pinhole 20 is provided in the optical sensing system 5 of the smoking article 2. A typical change of distance d₂ to the detector, represented by the symbol Δd in the enlarged view of FIG. 1b may be between 0.05 and 0.9 times the object distance d₂ (FIG. 1a), preferably between 0.1 and 0.5 times the object distance d₂. The pinhole 20 may additionally or alternatively be configured so that its aperture D may be changed, as illustrated in FIG. 1b by the symbol ΔD. Possible changes ΔD of the diameter D of the pinholes are typically between 10% and 80% of the diameter D of the aperture of the pinhole 20. More specifically, the pinhole 20 can be provided in a wall of the receiving portion 202, wherein the receiving portion 202 serves to accept the consumable article 1. A gap 200 exists between the consumable article 1 and the smoking device 2. The optical sensing system 5 comprises a pinhole 20 and an image detector 30 which is placed in a chosen position in the image plane. Of course, it is also foreseen that the image detector 30 according to the present invention does not need to be always placed on the image plane.

In the Figures, the distance between the image detector 30 and the pinhole 20 is represented with d₂ while the distance between the pinhole and the indicium 10 of a consumable article 1 is represented with d₁. When the consumable article 1 comprising an indicium 10 is inserted into the receiving portion 202 of the smoking device 2, an image of the indicium 10 can be formed by the pinhole 20 on the image plane and subsequently be detected by the image detector 30 of the optical sensing system 5. In this connection, a light source such as an LED (not illustrated) can be provided in proximity to the pinhole 20 to direct light towards the indicium 10. The image detector 30 may be placed anywhere in the smoking device 20 as far as the image formed on the image plane can be transferred and/or detected by the image detector 30.

FIG. 1a illustrates one of the simplest systems according to an embodiment where a single adaptable pinhole 20 is provided in the optical sensing system 5. The portion 4 of the consumable article 1 is provided with an indicium 10, which may be an image indicium or a coded indicium such as a printed code realized by ink. The indicium 10 may be a typical barcode or may be a 1D or 2D arrangement of a plurality of dots.

FIG. 1b shows a close-up view of the optical sensing system 5 provided with an adaptable pinhole 20. The indicium 10 may preferably be provided on a wrapper of the consumable article 1. The term “wrapper” is defined broadly as any structure or layer that protects and contains for example the charge of smoking material, and which allows handling of that material. The wrapper has an inner surface that may be in contact with the smoking material and has an outer surface away from the smoking material. The wrapper may preferably comprise a cellulose-based material such as paper but may also be made of a biodegradable polymer or may be made of glass or a ceramic. The wrapper may be a porous material and may have a smooth or rough outer surface and may be a flexible material or a hard material. A wrapper may constitute an optically opaque or partially transparent optical layer. In the case of paper, a wrapper is partially transparent in the visible and in the infrared and may be partially transparent in the ultraviolet. A wrapper may comprise apertures. Said indicium 10 may be at least partially aligned with the at least one aperture provided in the surface of the wrapper.

The indicium 10 may also be arranged according to a 2D or 3D arrangement of structures and may have any shape such as a square, or a rectangular shaped band. Preferably said band comprises an array of redundant code elements that are arranged on a complete circumference of said article 1. The term “redundant” herein means that the indicium 10 comprises an array of repetitive code elements, or blocks of code elements, so that it may be read by a fixed optical reader, independent of the position of the article 1, such as the angular position, relative to the optical reader system. This may be realized for example, without limitation, by an indicium 10 that is constituted by an array of reflective or diffractive structures, an array of absorptive structures, an array of resonating waveguides or a combination of them.

Apart from anti-counterfeit properties it is desired that the indicium 10 may also contain information of specific parameters that should be used by the smoking device 2 such as the ideal temperature range, or the heating profile in function of time, or parameters which allow the smoker to be provided with different smoking tastes or intensities.

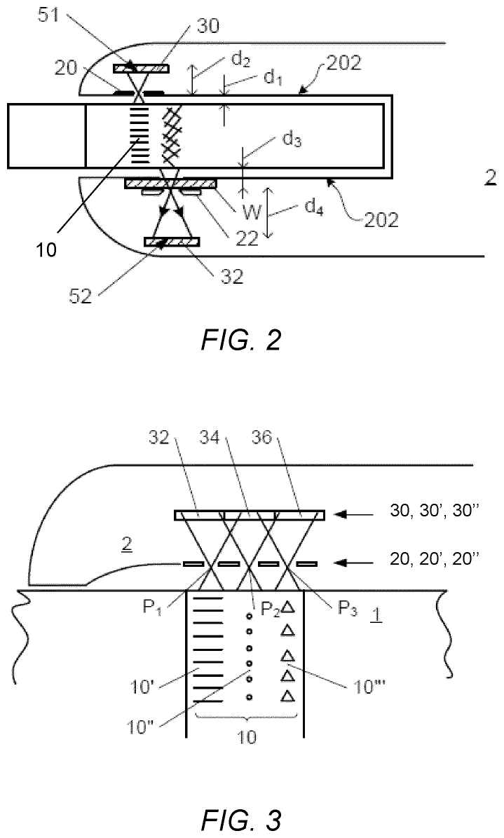

FIG. 2 shows a second embodiment of the present invention where two pinholes 20,22 are provided in two opposite walls of the receiving portion 202 of the smoking device 2. As the adaptable pinholes 20,22 are not provided at the same axial and/or longitudinal position, images 51,52 having information from different parts of the indicium 10 of the consumable article 1 can be formed on respective image planes and subsequently be detected by the respective image detectors 30,32. In other words, the first pinhole 20 allows a first part of the indicium 10 to form a first image 51 on one image plane while the second pinhole 22 allows a second part of the indicium to form a second image 52 on another image plane. These two images 51,52 are subsequently detected by the image detectors 30,32 of the optical sensing system. The image detectors 30,32 are placed in the image planes of the images 51,52. Otherwise, the adaptable pinhole according to this embodiment may be similar to the first embodiment, for instance the distance d₁ is identical to d₃, and d₂ is identical to d₄. In this embodiment, at least two identical pinhole images are used. FIG. 2 shows a layer W on which the second pinhole is formed. The layer W may be a thin glass plate for example. In variants, both adaptable pinholes 20,22 may be formed as apertures, in for example a Silicon (Si) chip, or both may be formed by a coating on a transparent plate W. Nevertheless, it is foreseen that two different adaptable pinhole imagers may also be provided, wherein each pinhole imager 51,52 provides a different variable magnification factor M1,M2.

In all embodiments of the invention the variable magnification factor M1,M2 is preferably greater than 1 but may be smaller than 1 or equal to 1.

FIG. 3 shows a further embodiment according to the present invention where a plurality of displaceable or deformable pinholes 20,20′,20″ are provided in the same wall of the receiving portion 202 but are arranged at different axial positions. In this embodiment, the adaptable pinholes 20,20′,20″ are arranged close to each other, wherein images which pass through the pinholes 20,20′,20″, respectively, form on the image plane and are partially overlapped with each other such that information 10′,10″,10″′ from different parts of the indicium 10 are projected on the image plane and subsequently detected by the image detectors 32,34,36 of the optical sensing system.

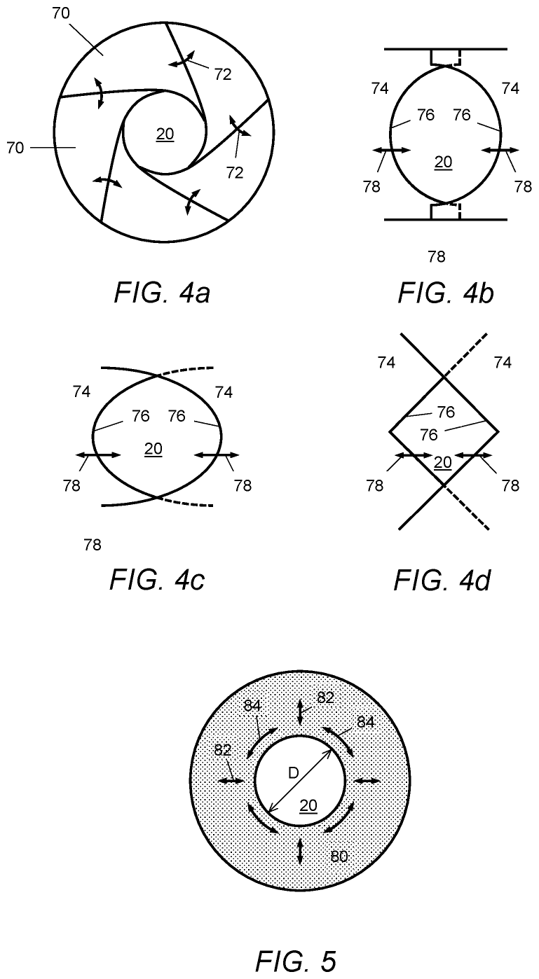

When the pinhole (20) is adaptable by changing its size, the size may be changed by a mechanism involving electromagnetic or electrostatic forces, such as applied by piezo elements, or any MEMS actuator based on forces (e.g. a MEMS magnetic actuator). FIGS. 4 and 5 show schematic examples of how variable size pinholes (20) may be effected.

The ideal shape of a pinhole is circular to avoid artefacts in the image. FIG. 4a shows an approximately circular pinhole (20) formed by curved blades (70) arranged in the manner of the iris aperture of a camera. The blades (70) may be synchronously pivoted, as indicated by arrows (72) to enlarge or reduce the size of the pinhole aperture between them. In the illustrated example, the number of blades (70) is five but it may be higher or lower. Increased the number of blades makes the shape of the pinhole (20) approximate a circle more closely but at the expense of added mechanical complexity.

FIG. 4b illustrates a simpler variable pinhole (20) formed by just two opposite MEMS blades (74), each of which comprises a half-circular edge (76). In one position, the two half-circular edges (76) form a full-circular aperture between them. The blades (74) may be controlled, for example, by electrostatic addressing to move towards or away from one another, as indicated by arrows (78), and change the area of the aperture. As the blades (74) move closer to each other, the width of the aperture decreases accordingly but the height of the aperture decreases by a smaller amount so the shape of the aperture becomes less circular.

FIG. 4c illustrates another variable pinhole (20) formed by two opposite MEMS blades (74). This example is very similar to that of FIG. 4b, except that the blade edges (76) are not half circles. In the illustrated example they are ellipses but other shapes, such as parabolic, are possible. The blade edges (76) in FIG. 4c follow curves that are more flattened in the vertical direction than the half-circular blade edges (76) of FIG. 4b. This may provide an advantage that, although the aperture is not truly circular at any position of the blades (74), its height may remain more closely equal to its width over a wider range of positions so in that sense it may more closely approximate a circle.

FIG. 4d illustrates a further variable pinhole (20) formed by two opposite MEMS blades (74). In this example, each blade (74) has an edge (76) forming a concave right-angle, whereby the aperture formed between the blades (74) is square. While a square aperture does not approximate a circle very closely, it provides the possible advantage that the shape of the aperture remains consistent as its size is changed by moving the blades (74) towards or away from one another.

FIG. 5 illustrates a different form of pinhole (20) that is formed as a circular aperture in a flexible material (80). This can be achieved at the small scales of the present invention, using MEMS processes. Materials that may be provided in sheet form and micromachined for this purpose could include metals or semiconductors such as silicon. Other suitable materials may include heat resistant polymers. By techniques such as changing an applied potential difference, the flexible material may be caused to expand or contract radially, as indicated by a first set of arrows (82), and/or circumferentially, as indicated by a second set of arrows (84), thereby changing the diameter D of the pinhole aperture while it remains circular in shape.

In this specification, the terms “size” and “diameter” are used interchangeably in relation to the adaptable pinhole (20) and should not be interpreted as limiting the aperture of the pinhole to a circular shape. In cases where the pinhole (20) is not circular, its size (or “diameter”) may be any suitable linear measure of the scale of the pinhole. In some situations, for example when the primary consideration is the resolution of the pinhole, the greatest distance across the aperture may be the most suitable measure. If the pinhole is in the form of a slit, then the width of the slit may be the most suitable measure. In other situations, for example when the primary consideration is the light-gathering capacity of the pinhole, the overall area of the aperture may be more significant and the size may be determined by calculation from the area (A), for example in proportion to the square root of the area. If the following formula is used for the size, D, then it will give a result equal to the conventional diameter in the case of a circular aperture:

$$D = √ ( 4 A / π )$$

The dimension of the displaceable or variable aperture pinhole 20, 20′, 20″ and its distance d₁ to the indicium and its distance d₂ to the image detector 30 have to be determined in consideration of the available space and the needed amplification or reduction of size of the image, which are determined only by the ratio d₂/d₁. The size of the aperture of the pinhole should be as small as possible but there is a trade-off to be found between the available intensity and diffraction effects and also the required resolution of the image of the indicium. For example, the greater the “projection distance”, the greater will be the magnification factor M and the resolution. Smaller projection distances give a wider view but a smaller resolution.

According to some embodiments, in an optical sensing system comprising at least one pinhole and an image detector, the pinhole may be provided in the following conditions:
Substrate: Fused silica, B270, Borofloat, D263,
Thickness: 0.3 mm to 10 mm
Coating material: Chrome or any thermal barrier coating
Pinhole diameter: At least 2 μm
Pinhole diameter tolerance: 0.5 μm
Position accuracy: Better than 0.5 μm

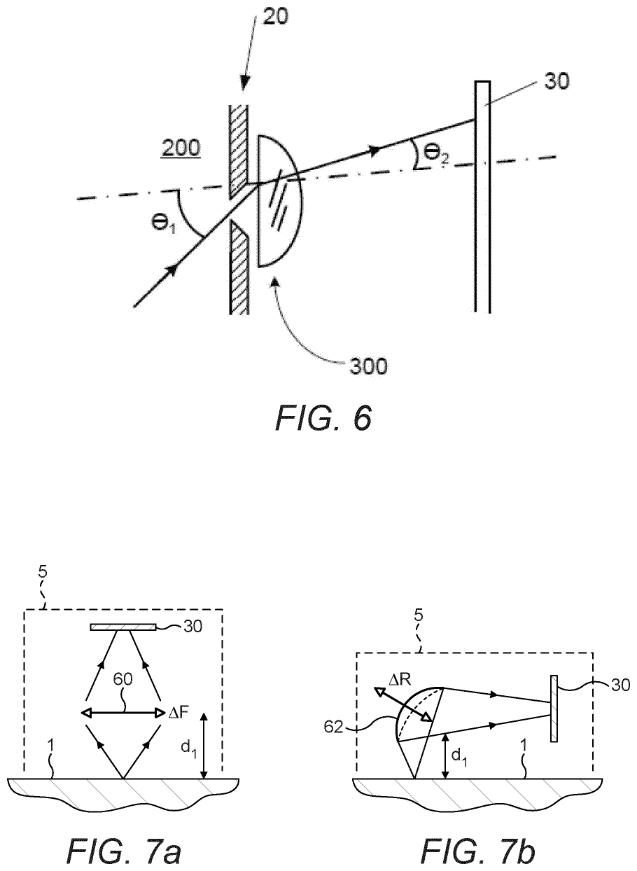

It is disclosed that the according to one further embodiment, the field of view of an adaptable pinhole imaging system, comprising a displaceable or deformable pinhole, can be enlarged by placing a field lens 300 behind the pinhole 20, as illustrated in FIG. 6. In this connection, it is noteworthy that because the incident light comes effectively from a point source, the field lens 300 does not itself produce an image but merely deviates the rays of light, as shown by the difference between incident angle θ₁ and emerging angle θ₂, which is not to be equated to a focusing micro lens. In an embodiment the field lens 300 may be an adaptable field lens.

The adaptable micro optical sensing system of the present invention may comprise an optical projection system having a magnification factor greater than 1, and at least one image detector. The image detector may be a single detector, a detector array, a detector system comprising optical elements and electronics, or may comprise an imager and/or or a miniaturized spectrometer.

It is emphasized that in all embodiments of the present invention, an illumination system as well as a heating system can be integrated in the imaging system. All the embodiments described herein may be adapted to transmit also an illumination beam that is provided by a light source arranged in the optical sensing system 5 or as a separate component in the smoking device 2, for instance, provided to the side away from an indicium 10. This may be realized by using for example a beam splitter or a semi-transparent mirror. Arranging an illumination beam in optical systems, such as a microscope, is well known and is not further described herein.

The light source or illuminating system can be any source that may provide a light beam, preferably in the range of ultraviolet (UV), visible or infrared (IR) light. A light source may be for example a LED or a semiconductor laser. The light source may emit narrow band or monochromatic light, such as near infrared light, which reduces the chromatic aberration that can occur if one uses broadband light. The light source need not be necessarily an independent, power-driven light source, and thus may for example be a part or an area of a heater or a hot part of the aerosol generating device and/or or the consumable article that provides a beam of infrared light.

Upon illumination by the light source, the indicium 10 of a consumable article 1 will generate a projected light beam, which can be a reflected, transmitted or diffracted light beam. The projected light beam may provide, after reflection or refraction or diffraction by a first focusing element, at least one secondary light beam that is transmitted onto an image detector 30 directly or by using for example single or compound reflective, refractive or diffractive elements, beam splitters or a combination of such elements.

Said projected light beam is then received on an image detecting system or optical sensing system, which is also defined as an image detector 30 as used herein, which includes means to convert optical information provided by at least one indicium 10 of a consumable article into an electrical signal or data that may be used to recognize the article and/or identify information related to the parameters of the smoking device 2, for example parameters that should be used, in operation of the smoking device 2, for said consumable article 1. An optical sensing system 30 may comprise a single detector or a detector array or may comprise a vision system. The optical sensing system 30 may also comprise colour filters or a miniaturised spectrometer.

In some variants it may be necessary to provide an adaptable projection system having a significant variable magnification factor, for example a factor of 10 or more than 20 or more than 50. In some instances, due to the lack of space in a typical aerosol generating device, the optical path may be deviated by using at least one secondary deflection mirror, which may be a flat or a curved mirror. In variants, not illustrated herein, the adaptable optical magnification system may be based on a catadioptric configuration using both lenses and mirrors. This allows the provision of a compact adaptable optical system while at the same time providing a long projection length and thus a high magnification factor.

Realizing arrays of micro holes in metal layers on transparent layers is a widely available technology. Moreover, very precise micro-structured apertures may also be realized in silicon (Si) by MEMS technologies. In MEMS materials the apertures may have a V-shape in cross-section, as illustrated in the Figures. Apertures may be realized on small field lenses as illustrated in FIG. 6. MEMS technologies allow furthermore to realize not only displaceable but also variable aperture pinholes.

In some further embodiments, the optical sensing system comprising one or more pinholes may be provided in a more sophisticated manner. Either the pinholes are adaptable themselves or they are arranged in an adaptable optical microsystem. For instance, pinhole arrays and optionally spatial filters may be used for spatial filtering and act as virtual point light sources in many optical systems. A pinhole (or also known as a pinhole aperture) limits the numerical aperture (divergence) and blocks larger angles.

In some further examples, Nipkow discs which are used in confocal microscopy may also be provided to the adaptable optical sensing system according to the present invention. As part of the lighting system, they are also found in fluorescence microscopy and material testing. The elements feature pinholes, which are arranged in a ‘Nipkow pattern’ on a planar substrate, ensuring that there are no defects during the micro-structuring of the black chrome coating. This is because even the smallest of defects in the size of a pinhole diameter will lead to streaking in the image, thereby rendering the disc unusable.

In another example, the distance d₂ between the pinhole 20 and the image plane may be between 1 mm and 20 mm or between 2 mm and 10 mm, without limitation. The distance d₁ between the indicium 10 and the pinhole 20 may be between 0.5 mm and 5 mm or between 1 mm and 3 mm, also without any limitation. The choice of d₁, d₂ and the pinhole type and its diameter depends on each particular geometrical arrangement according to the particular design of the available space in the smoking device so that imaging of indicia of smoking articles may be imaged. In certain variants, a small mirror may be arranged in between the pinhole and the detector, or a microprism may be used to deflect the light to the image detector 30.

In order to achieve the sharpest image, the hole ideally should be of the optimum size, perfectly round and preferably be made from the thinnest material. Nevertheless, sharpness alone does not always have to be the most important requirement. The principle of the pinhole ensures that the image of a point is, in fact, a small disc. The smaller the hole, the smaller the disc and hence the sharper the image. Nevertheless, this is only true up to a point. If the hole is too small, then light is diffracted and the image becomes less sharp. Hence, an optimum hole diameter exists for each focal length (distance from the hole to the light-sensitive material) which will create the sharpest picture. The equation of an optimal pinhole diameter may be based on the formula proposed by Lord Rayleigh, revised so that the result gives the diameter, not the radius, can be written as follows:

$$D = 1.9 √ ( f \cdot λ )$$

wherein
D—pinhole diameter;
f—focal length;
λ—wavelength (usually the wavelength for yellow/green light 0.00055 mm is used).

The calculation of the optimum hole diameter or the optimum focal length can be made using any commonly known method that is available to skilled persons. For instance, the calculation can be made using a Pinhole Designer program.

It is disclosed that the pinhole according to the present invention can be provided as a size-variable pinhole. The size-variable pinhole may also be at the same time a pinhole that may be displaced or vibrated. For instance, the pinhole size may be changed by a mechanism involving electromagnetic or electrostatic forces, such as applied by piezo elements, or any MEMS actuator based on forces (e.g. MEMS magnetic actuator). As the dimensions of a pinhole used with the invention are very small, it is easy for an applied voltage to create huge electric forces. In an example, the pinhole is formed by two opposite MEMS blades that may be addressed by electrostatic addressing. In another example, each of the two MEMS blades may comprise a side with a half-circular aperture (or a half-pipe shaped on one side). The two half-circular shaped apertures form a full-circular aperture when the blades are laterally in contact with each other. The area of the aperture may be adapted by moving the two blades, thereby the pinhole size is adjustable.

Referring back to FIG. 1a, the optical sensing system must be very small to fit alongside the consumable article within the confined space of the smoking device. Accordingly, the focal length of the optical element, which in general may comprise one or more of a lens, mirror or pinhole, must be very short. Such a system may be particularly sensitive to variations in the distance di between the indicia and the optical system, for example because of irregularities in the surface of the consumable article or a departure of the shape or diameter of the article from expected values. Such variations may result in the indicia appearing out of focus to the optical system or suffering a loss of contrast and may limit the ability of the optical system to read the indicia reliably. even in the case of a pinhole, which has good depth of focus, an increase in the distance d₁ will result in a decrease in the size of the image projected on the image plane 30, which may reduce the resolution of the image of the indicia.

According to the present invention, the smoking device comprises means for adapting a characteristic of the optical sensing system in response to a distance of the indicia from the optical sensing system. The adaptation is not limited herein to the use of adaptable pinholes but may be realized by optical microsystems that may comprise lenses or mirrors or other optical elements and materials as described now.

FIGS. 7a and 7b schematically illustrate a first approach to implementing this solution, namely to adapt the focal length of the optical sensing system to the distance of the indicia from the optical sensing system. In FIG. 7a, the optical sensing system is a refractive system that comprises a converging lens 60 having a focal length F. It can be seen that, because the distance di of the article 1 from the lens 60 is greater than an intended distance, light rays from a point on the surface of the article 1 fail to converge to a point on the image detector 30. By providing the lens 60 with a variable focal length ΔF, as described in more detail below, it can adapt to variations in the distance d₁, whereby the light rays can be brought to a focus and the performance of the optical sensing system can be improved.

In FIG. 7b, the optical sensing system is a reflective system that comprises a concave mirror 62 having a focal length that depends on its radius of curvature R. It can be seen that, because the distance di of the article 1 from the mirror 62 is greater than an intended distance, light rays from a point on the surface of the article 1 fail to converge to a point on the image detector 30. By providing the mirror 62 with a variable radius AR, as described in more detail below, its focal length can be adapted to variations in the distance di, whereby the light rays can be brought to a focus and the performance of the optical sensing system can be improved.

Through the use of an adaptive optical element 60,62, the optical sensing system 5 can preferably be adapted to variations in the distance di without the need to bodily move the optical element 60,62 or the entire optical sensing system 5, therefore once the consumable article 1 is received in the smoking device 2, the distance di remains fixed and the system adapts to it. In most of the examples described below in accordance with the invention, the adaptive optical element 60,62 comprises an optical surface that is deformable to change the focal length of the element 60,62.

An optical sensing system may comprise a combination of optical elements, including lenses, mirrors or both kinds. In such combinations it is normally only necessary for one of the optical elements to be adaptive but the provision of multiple adaptive optical elements is not excluded from the invention.

It should be understood that although the focal length F of the optical sensing system 5 adapts to the distance d₁ of the indica from the optical element, it is not normally equal to the distance d₁. If that were the case, a converging lens 60 or concave mirror 62 would focus the image at infinity so a further optical element would be required to bring the image to a focus on the image detector 30. Instead, the focal length F changes as a function of the distance d₁, for example in proportion to d₁.

In the case of a thin lens in air, the focal length (F) is related only to its refractive index (n) and its radii of curvature (R₁, R₂):

$$1 / F = ( n - 1 ) \times ( 1 / {R}_{1} - 1 / {R}_{2} )$$

The sign convention is such that, for a biconvex lens, R₁ is positive and R₂ is negative.

For a flat-convex lens (R₂=infinity):

$$1 / F = ( n - 1 ) / {R}_{1} or$$

$$F = {R}_{1} / ( n - 1 )$$

Therefore, to change the focal length F of a thin lens it is sufficient to change only its refractive index and/or its radius of curvature.

For the physics of lens optics reference is made to the basic text book:

Eugene Hecht and Alfred Zajac, “Optics”, Adison-Wesley Publishing Company, 1980 or its French version 2002, Pearson Education France, ISBN 2-7440-7063-7.

To change the focal length F of a concave mirror, it is sufficient to change only its radius of curvature.

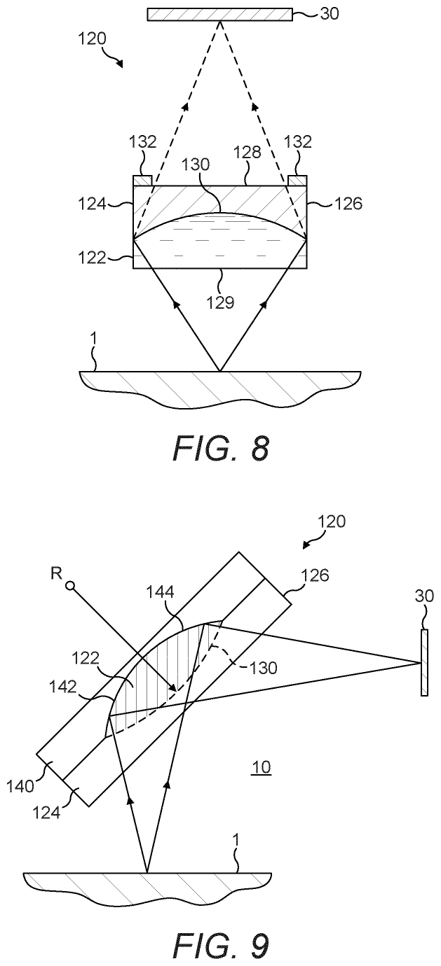

FIGS. 8 to 14 illustrate embodiments of the invention in which the focal length of the optical sensing system 5 is adapted by changing the curvature of at least one surface of an optical element. In FIGS. 8 to 11, the adaptive optical element is based on a deformable interface between two non-miscible liquids such as water and oil. The two liquids have different refractive indices so the interface forms an optical surface that refracts light passing therethrough. The deformable interface is curved to act as a lens, the power of which is determined by its curvature.

FIG. 8 illustrates an embodiment of the invention comprising an optical element 120, in which a first liquid 122 having a relatively high refractive index and a second liquid 124 having a relatively low refractive index are contained with a chamber 126 having parallel upper and lower faces 128,129. The chamber 126 may be circular, centred on the axis of the optical element 120, but other shapes are possible as described below. The first and second liquids 122,124 are immiscible so they separate from one another to form an interface 130 between them. They preferably have substantially the same density. Both liquids 122,124 are transparent to light of a wavelength that may be detected by an image sensor 30. The light may be ambient light or may be provided by a light source (not illustrated) such as a near-infrared LED. Because of interactions between the liquids 122,124 and the walls of the chamber 126 and/or as the result of applying a voltage (described below), the interface 130 develops a curved shape to act as a lens.

Light emitted from the surface of an article 1, which may carry indicia, passes through the lower face 129 of the chamber 126 to be transmitted through the first liquid 122. It then passes through the interface 130 and is refracted into the second liquid 124 of lower refractive index. The light emerges through the upper face 128 of the chamber 126 to arrive at the image sensor 30. For a suitable value of the curvature of the interface 130, light from an indicium on the article 1 will be brought to a focus to form an image of the indicium on the image sensor 30. It may be assumed that, as least for light rays close to the axis of the optical element 120, the light will not deviate significantly as it passes through the flat upper and lower surfaces 128,129 of the chamber 126. An opaque frame 132 may be provided around the upper surface 128 (or the lower surface 129) to define the aperture of the optical element 120. It should be noted that FIG. 8 is purely schematic: the divergence of the light rays is exaggerated for clarity and the illustrated angles of refraction are not physically realistic.

FIG. 9 illustrates a further embodiment of the invention, in which the two liquids 122,124 are again contained within a chamber 126 but are also in contact with a common substrate 140. A cavity 142 in the substrate 140 is provides a reflective surface 144 that acts as a mirror to redirect light rays from the article 1 towards an image sensor 30. The reflective surface 144 is preferably curved to act as a concave mirror that makes the light rays converge towards the image sensor 30. The substrate 140 may, for example, be formed in silicon, whereby the cavity 142 can be configured by wet etching techniques to have walls that are well defined by the etching properties of silicon. Batch processing techniques may be used to form multiple such substrates in a single wafer, which is subsequently diced into separate substrates for individual optical elements 120.

A drop or small volume of the first liquid 122, which has a relatively high refractive index, is located within the cavity 142, while the second liquid 124, which has a relatively low refractive index, fills the remainder of the chamber 126. The first and second liquids 122,124 are immiscible so they remain separate and an interface 130 forms between them. Because of interactions between the liquids 122,124 and the substrate 140 and/or as the result of applying a voltage (described below), the interface 130 develops a curved shape to act as a converging lens in front of the concave mirror. By the first liquid 122 shrinking into a shape that more closely approaches a sphere, the surface area of the interface 130 is reduced and the overall energy of the system may also be reduced. The shape adopted will also depend on the respective affinities of the first and second liquids 122,124 for the substrate 140. At the small scale of a typical optical sensing system 5 for use in a smoking device, surface effects can be more significant than gravitational forces and may, for example, be sufficient to hold the first liquid 122 in the cavity 142, even when it is inverted as shown in FIG. 9. It is not essential that the first liquid 122 exactly fills the cavity 142: particularly as the curvature of the interface 130 changes, the margins of the first liquid 122 may move to be inside or outside the rim of the cavity 142.

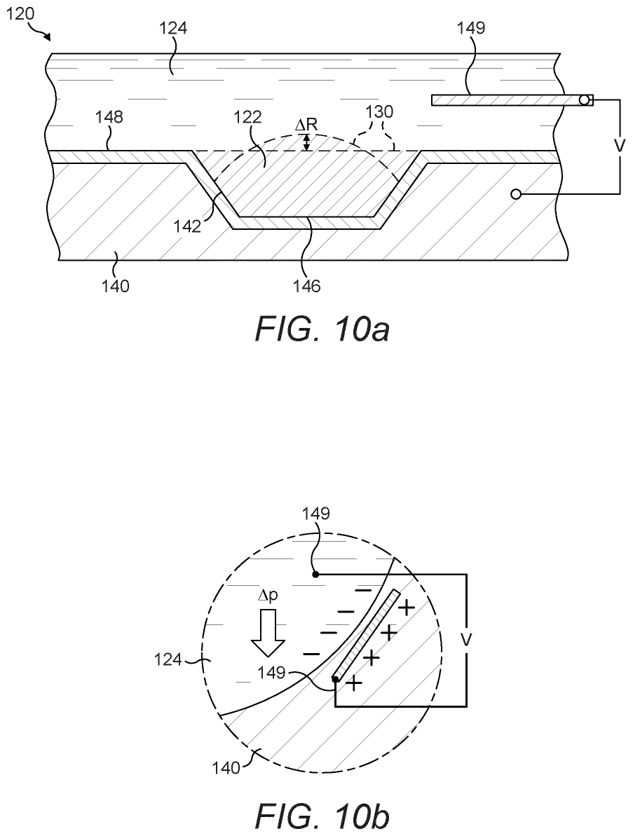

FIG. 10a illustrates a further embodiment of the invention, which is similar to that in FIG. 9, except that the base of the cavity 142 is formed as a planar reflective surface 146. Thereby the surface 146 does not contribute any converging power, which is provided solely by the curved interface 130, through which the light rays pass twice, on entering and exiting the optical element 120. FIG. 10a also illustrates how the substrate 140 may be provided with a coating 148 having different properties from the bulk material of the substrate 140, for example with respect to its reflectivity, its conductivity or its affinity for the respective liquids 122,124. The coating 148 is preferably a dielectric material. If the bulk material of the substrate is silicon (Si), the surface coating may be silicon dioxide (SiO₂).

FIG. 10a also illustrates a pair of electrodes 149, which respectively contact the substrate 140 and the second liquid 124. A voltage source is provided for applying a potential difference (V) between the electrodes 149. As illustrated schematically in the plan view of FIG. 10b, this may induce charges at the surface of the substrate 140 and opposite charges at the margin of the second liquid 124, which is preferably a polar fluid. Varying the potential difference may change the affinity of the second liquid 124 for the substrate 140. This “electrowetting” effect creates a hydrostatic pressure (p), which may cause the drop of the first liquid 122 to change its shape to increase or decrease the area of contact between the second liquid 124 and the substrate 140. As a result, the radius of curvature (R) of the interface 130 also changes and by this means the level of the applied potential difference (V) can be used to adjust the focal length of the optical sensing system 5.

As discussed, the first liquid 122, which is located in the cavity 142, may be a non-polar fluid such as a transparent oil and the second liquid 124, which is located outside the cavity 142, may be a polar fluid such as water. Alternatively, the first liquid 122 may be non-conductive and the second liquid 124 may be conductive, the substrate 140 being conductive and its surface coating 148 being insulating. The conductive liquid may be, for example, a solution of salt. By the application of a potential difference between the conductive second liquid 124 and the electrically conductive substrate 140, the interface 130 between the liquids will be deformed to change the focal length of the optical element 120. Salts such as sodium sulphites are a good choice for the conductive solution as their solubility is very stable over a wide range of temperatures. Their optical characteristics will not change over a wide range of temperatures and are not influenced by the local electric fields that are formed. For the conductive liquids, bromides may be another good choice. The non-conductive liquid may be an oil, an alkane or a mixture of alkanes, possibly halogenated alkanes. The choice of the first and second liquids depends on the required optical properties and the temperature of the operating environment. It is mandatory to choose non-miscible liquids and it is also important to consider the kinematic viscosity of the pair of liquids.

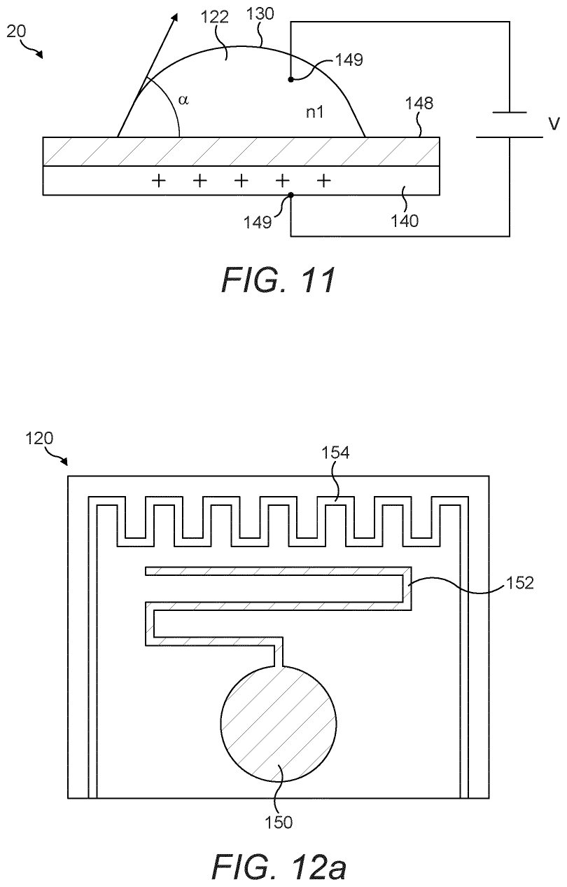

The embodiment of the invention illustrated in FIG. 11 is a further variant, which is generally similar to the embodiment in FIG. 10a. However, in this example there is no second liquid, the adaptive lens 120 being formed solely by a drop of the first liquid 122 on the substrate 140. The optical surface 130 therefore comprises the interface between the first liquid 122 and the surrounding air. The difference in refractive index between the first liquid 122 and air will be greater than the difference in refractive index between the first liquid 122 and a second liquid, therefore, for a given curvature of the optical surface 130, this optical element 120 will have greater focusing power and a shorter focal length. In some examples, the substrate 140 may be transparent so that the light is transmitted through the optical element 120 instead of being reflected from the substrate 140 to pass twice through the optical surface 130. In some examples, the substrate 140 may be planar, whereby the first liquid 122 is not contained in a cavity. Alternatively, the substrate 140 may be curved and reflective, like the substrate 140 illustrated in FIG. 9, to act as a concave mirror. Again, a surface coating 148 may be formed on the substrate 140 to provide it with different electrical or optical properties where it contacts the first liquid 122.

FIG. 11 also illustrates a pair of electrodes 149, which respectively contact the substrate 140 and the first liquid 122. A voltage source is provided for applying a potential difference (V) between the electrodes 149. Varying the potential difference may change the affinity of the first liquid 122 for the substrate 140. This “electrowetting” effect may cause the drop of the first liquid 122 to change its shape by increasing or decreasing the area of contact between the drop of liquid 122 and the substrate 140 or by changing the contact angle (α) between the drop of liquid 122 and the substrate 140. As a result, the radius of curvature (R) of the interface 130 also changes and by this means the level of the applied potential difference (V) can be used to adjust the focal length of the optical sensing system 5.

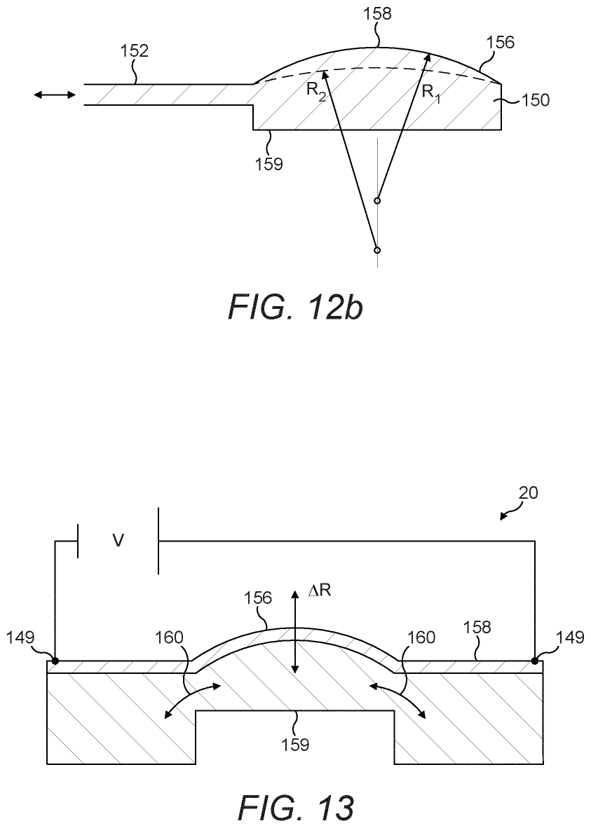

FIG. 12a is a plan view and FIG. 12b is a cross-section, both of which schematically illustrate a further embodiment of the invention. In this embodiment, the adaptive optical element 120 comprises a cell 150 filled with a transparent fluid, which may be an oil such as silicone or a gel. The cell 150 is coupled to a reservoir 152 of the fluid, which may be in the form of a convoluted micro-channel, the fluid being sealed within the cell 150 and the reservoir 152. A heater 154, such as a resistive element, is disposed adjacent to the reservoir 152 and may be energized to increase the temperature of the fluid in the reservoir 152. The increased temperature causes the fluid to expand, pushing more fluid from the reservoir 152 into the cell 150. At least one wall of the cell 150 is formed by a transparent, resilient membrane 156. As the volume of fluid in the cell 150 increases, the resilient membrane 156 deforms to accommodate it, thereby increasing the curvature of the membrane. Conversely, if the heater 154 is de-energized or its intensity is reduced, the temperature of the fluid in the reservoir 152 decreases and the membrane 156 resiliently contracts to displace fluid from the cell 150, at the same time reducing the curvature of the membrane 156. It will immediately be understood that the cell 150 can be used as a converging lens in an optical sensing system 5, wherein the membrane 156 defines an optical surface, the focal length of which may be controlled by varying the electrical current through the heater 154. As illustrated in FIG. 12b, only the upper wall 158 of the cell 150 is formed by a resilient membrane 156 so the optical element 120 takes the form of a plano-convex lens. It will be understood that in an unillustrated variant, the lower wall 159 of the cell 150 could similarly be formed by a resilient membrane 156 so the optical element 120 would instead take the form of a bi-convex lens.

FIG. 13 schematically illustrates another embodiment of the invention, which is similar to FIG. 12 to the extent that a fluid is contained in a cell 150 by a deformable membrane 156. In this case, the volume of fluid within the cell 150 is fixed (subject to changes in the ambient temperature) but applying a potential difference between two electrodes 149 causes the distribution of the fluid to change. More specifically, at least one wall 158 of the cell 150 comprises a deformable membrane 156 in at least a central region of the wall 158. The membrane 156 is in the shape of a dome, which creates a curved optical surface 130 between the fluid and air on the other side of the membrane 156. The optical element 120 can therefore serve as a converging lens. In this embodiment, the electrodes 149 are in contact with the membrane 156 on opposite sides of the central region and the membrane 156 is formed from a material that changes its shape when subjected to high voltage. With a suitable configuration of the membrane 156, shape of the cell 150 and positions of the electrodes 149, it can be arranged that changes in the potential difference (V) between the electrodes 149 cause changes in the curvature of the membrane 156. Accordingly, the applied voltage can be controlled to adapt the focal length of the optical element 120 in response to its distance from the indicia.

As the membrane 156 deforms, fluid flows between the central region and the periphery of the cell 150 to fill the space behind the membrane 156, as shown in FIG. 13 by arrows 160. If the domed central region of the membrane 156 rises, then, in order to keep the volume of the cell 150 constant, a peripheral region of the membrane 156 may need to fall (and vice versa). FIG. 13 shows how the flow of fluid may be regulated by making the cell 150 shallower in the central region. As illustrated in FIG. 13, only the upper wall 158 of the cell 150 comprises a resilient membrane 156 so the optical element 120 takes the form of a plano-convex lens. It will be understood that in an unillustrated variant, the lower wall 159 of the cell 150 could similarly comprise a resilient membrane so the optical element 120 would instead take the form of a bi-convex lens.

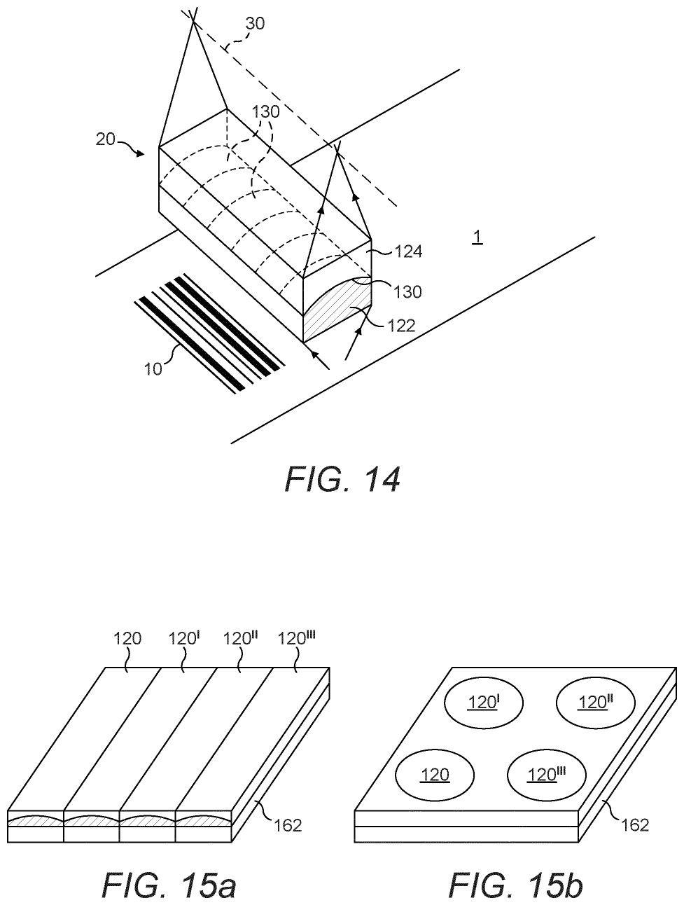

Each of the optical elements 120 illustrated in the foregoing FIGS. 8 to 13 has circular symmetry about an optical axis of the element. However, other shapes are possible within the scope of the present invention. In a variant illustrated in FIG. 14, the adaptive optical element 120 may be configured as a cylindrical lens. It can be seen that the cross-section of the element is substantially the same as in FIG. 8 and it works in substantially the same way. The only difference is that, instead of the lens bringing each point on the surface of the article 1 to a separate focus at the image sensor 30 to form a 2D image of the article 1, the lens of FIG. 14 can only bring to a separate focus each line on the surface of the article 1 that is parallel to the axis of the cylindrical lens. This is nevertheless useful if the information of interest is stored in only one dimension in the indicia 10, for example as a linear barcode. As seen in FIG. 14, the cylindrical lens 120 may be built up from an array of smaller lenses laid end-to-end along the cylindrical axis.

FIG. 15a illustrates how a planar array of indefinite size may be assembled from a plurality of cylindrical optical elements 120, 120′, 120″, 120″′ like those shown in FIG. 14, in order to form an image of a larger area than can be achieved by each element individually. The images formed by the respective optical elements 120-120″′ may be overlapped to form one large image on a common image sensor (not illustrated). Alternatively, each of the optical elements 120-120′″ may be associated with its own image sensor, the images from the respective sensors being used separately or combined in post-processing. The optical elements may be fixed to a common substrate 162, which may be transparent or opaque, according to whether the optical elements 120-120′″ are transmissive or reflective.

FIG. 15b illustrates how a planar array of indefinite size may be assembled from a plurality of optical elements 120, 120′, 120″, 120″′ having circular symmetry, like those shown in FIGS. 8 to 13, in order to form an image of a larger area than can be achieved by each element individually. The respective optical elements 120-120″′ may be arranged in a square lattice as shown, in a triangular lattice that allows closer packing of circular elements, or in any other suitable fashion. Again, the optical elements may be fixed to a transparent or opaque common substrate 162.

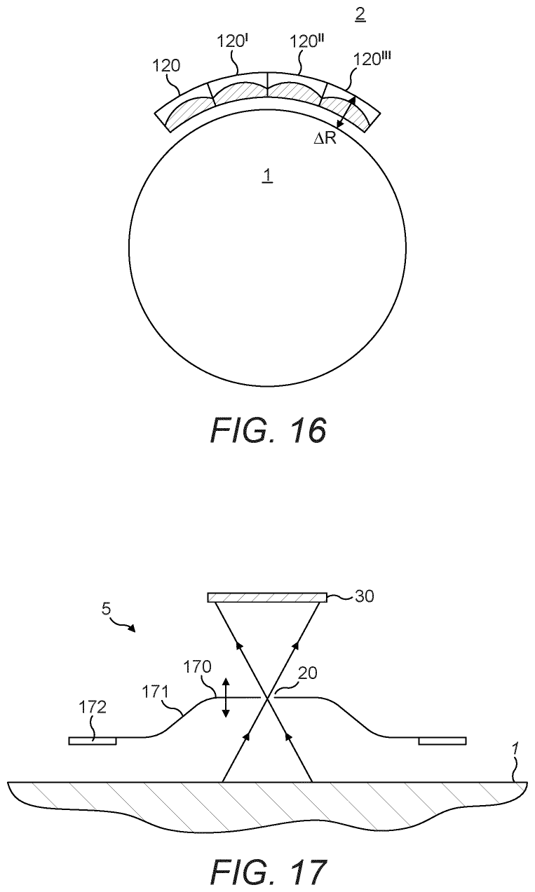

FIG. 16 shows how an optical sensing system 5 according to the invention may comprise an array of the adaptive optical elements 120, 120′, 120″, 120′″ similar to that shown in FIG. 15a but arranged to follow a curved surface. Adjacent elements 120-120″′ may be linked by a polymer bridge so that the array remains flexible and can easily be bent to conform to the curvature of a chamber in the smoking device 2 that receives the consumable article 1. Such an array of optical elements 120-120″′ may be used to read indicia that extend at least partly around the circumference of the consumable article 1. In other applications, such an array of optical elements 120-120″′ may be used to read indicia that are confined to a small part (or parts) of the circumference of the consumable article 1. If the consumable article 1 is capable of being received in different rotational orientations, then providing such an array of optical elements 120-120″′ guarantees that the indicia on the wrapper of the consumable article I will be readable by at least one of the elements, whatever orientation it is in.

It will be recalled that according to the present invention, the smoking device comprises means for adapting a characteristic of the optical sensing system in response to a distance of the indicia from the optical sensing system.

FIGS. 17 to 19 schematically illustrate in more detail the second approach to implementing this solution, namely, to adapt the position of at least an element of the optical sensing system in response to the distance of the indicia. In these figures, the optical element 120 is shown as a pinhole but the respective embodiments would need no significant adaptation to be used with optical elements 120 that additionally or alternatively comprise lenses and/or mirrors.

In FIG. 17, the pinhole 20 is formed in a central plate 170, which is supported by a support element 171, which in turn is anchored to a surrounding frame 172. The support element 171 may extend continuously around the central plate 170 or may comprise a plurality of arms distributed abound the periphery of the central plate 170.

The support element 171 may be integral with the central plate 170. Means are provided for flexing the support element 171 so that the central plate 170 moves towards or away from the image sensor 30, while remaining substantially parallel to it. This movement also changes the distance of the pinhole 20 from the surface of an adjacent consumable article 1, which may carry indicia to be read by the image sensor 30. Therefore, by flexing the support element 171, the respective distances of the pinhole 20 from the article 1 and the image sensor 30 can be balanced to adapt the focus of the optical sensing system 5 to its optimum value. In other embodiments, the image sensor 30 could be attached to the central plate 170, whereby the distance between the image sensor 30 and the pinhole 20 or other optical element 120 remains fixed as the central plate 170 moves towards or away from the adjacent consumable article 1. In such embodiments, the adapting means may be configured to maintain the optical element 120 at a predetermined distance from the indicia, the predetermined distance being, for example the focal length of the optical sensing system 5.

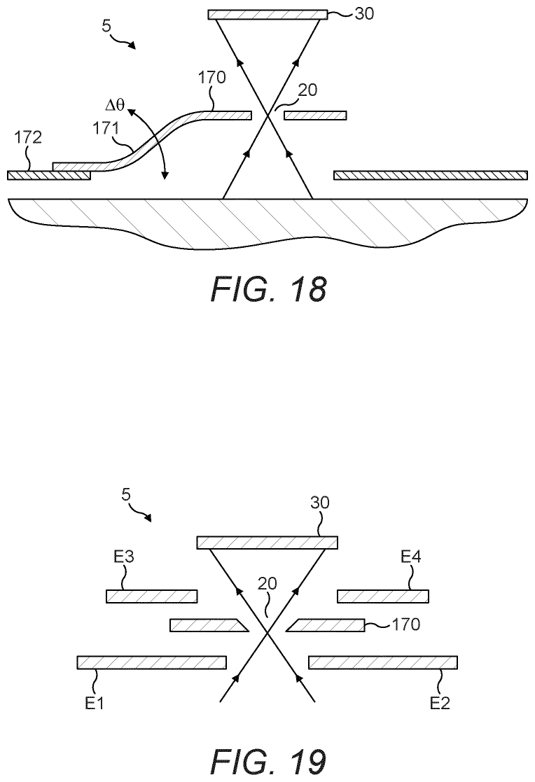

In FIG. 18, the pinhole 20 is again formed in a central plate 170, which is supported by a support element 171, which in turn is anchored to a frame 172. In this embodiment, the support element 171 supports the central plate 170 on only one side, which makes it easier to flex and simpler to design. Flexing the support element 171 again causes the central plate 170 to move towards or away from the image sensor 30 but, because the support element 171 supports the central plate 170 on only one side, the flexure also causes the angle (θ) of the central plate 170 to change. Reasonably small changes of angle (Δθ) will not adversely affect the operation of a pinhole 20 but the embodiment of FIG. 17 is preferred for an optical element comprising a lens or mirror, which is likely to be more sensitive to changes in angle. Both embodiments have the advantage that there are no “floating” components and no articulated connections.

Flexure of the support element 171 to deflect or displace the central plate 170 may be realized in different ways, preferably under electronic control, such as by using a piezodrive that would be attached or integrated to the support. Such a system may be realized in MEMS technology and thus may be manufactured by a batch process and at low cost. The central plate 170 and other components can be made small and because of their low inertia, the focal length of the optical sensing system 5 can be adapted at high frequency, typically within a few milliseconds.

FIG. 19 shows a further embodiment, in which the position of the central plate 170 is controlled using electric charges. Charge plates E1 and E2 lie in a lower plane, while charge plates E3 and E4 lie in a parallel upper plane. The central plate 170 is suspended between the upper and lower planes and parallel to them. It may be supported by a flexible support similar to those illustrated in FIGS. 17 and 18 so as to have freedom to move up or down. Electrical connections (not illustrated) may be provided to the upper charge plates E1,E2 and/or the lower charges plates E3,E4 and can be used to make them relatively more positively or negatively electrically charged, in order to attract or repel the central plate 170 and cause it to move upwards or downwards accordingly. An electrical connection may also be provided to the central plate 170 to adjust or determine the electric charge that it carries. The position of the central plate 170 may be maintained purely by controlling the balance of charges on the respective plates or by balancing the electrostatic force against a mechanical restoring force provided by a support element of the central plate 170. As discussed in relation to FIG. 17, in an alternative version of this embodiment the image sensor 30 could be attached to the central plate 170, whereby the distance between the image sensor 30 and the pinhole 20 or other optical element 120 remains fixed as the central plate 170 is moved.

In the aforementioned embodiments of the invention that use liquids to form adaptive optical elements, it is important to take into account the expected operating temperature of the device in the locality of the optical sensing system. The practical operating temperature of water and many other liquids is typically limited to lower than 80° C. For temperatures higher than 80° C., liquids comprising heat-resistive oils and polymers may be considered. For some applications, the optical sensing system may be required to withstand up to 200° C., which means that its mechanical, adherence (to substrates), and optical properties do not change up to at least that temperature. No significant changes should occur in its refractive index, transparency and surface or volume properties such that the optical components should remain transparent or reflective for a focused light beam, without it becoming scattered.

Materials such as SU-8 photoresist and high temperature polymers are good choices for manufacturing the solid elements of the optical sensing systems using established MEMS processes.

In accordance with the present invention, a characteristic of the optical sensing system is adapted in response to a distance of the indicia on the consumable article from the optical sensing system. In order to make an appropriate adaptation of the characteristic, the distance of the indicia from the optical sensing system may be determined in various ways. One way would be mechanical, using a spring-mounted element that rests against the surface of the consumable article when it is inserted into the cavity of the smoking device. The displacement of the element can be measured and used to determine the distance. Other ways of determining the distance could use range-finding technology, based on the time-of-flight of an optical or other signal emitted from the optical sensing system and reflected from the surface of the consumable article. The reader will be able to envisage other known devices, such as proximity sensors, that may be suitable. More preferably, because it avoids the need for additional components, the distance may be determined using the imaging capability of the optical sensing system itself. For example, a mark of known length may be applied to the surface of the consumable article then, by imaging the mark and comparing its apparent length or the angle it subtends with the known length, the distance to the surface can be calculated.

Alternatively, the characteristic of the optical sensing system may be adapted in response to a distance of the indicia from the optical sensing system without making any absolute determination of that distance. In this case, the indicia may be imaged continuously or repeatedly by the optical sensing system while the variable characteristic of the optical sensing system is changed, until the clarity of the image has been optimized. The characteristic may simply be scanned or cycled through its full range of possible values to select the value that gives the clearest image. Alternatively, a more “intelligent” search may be performed by continuously or repeatedly assessing whether the current direction of change of the characteristic is causing the sensed image to improve or worsen, then reversing the direction if necessary to home in on the optimum value of the characteristic.

An adaptive optical sensing system according to the invention preferably satisfies a number of conditions such as:
Its volume should be very small, such as 3 to 10 mm³, with a length of 1 to 4 mm.
The focusing action should occur with a very high speed, the system preferably achieving focus within 100 ms and more preferably within 10 ms or 1 ms.
The optical sensing system should be a self-contained system in the sense that it may be handled and mounted into a device as a unit. Ideally the unit has integrated mechanical fittings so that it may be easily clipped or glued onto a frame of a smoking device, such as a frame that may be integrated onto the heater or any other component of the device that is in proximity or in contact with the cavity of the device.
The optical sensing system may comprise a variable colour filter or a light shutter.
The optical sensing system should be low cost when fabricated in great quantities.
The optical sensing system should be made of low cost materials, preferably materials used in MEMS processes such as structured silicon (Si). Suitable materials may also be chosen among: metals, ceramics, glasses, sol-gel, metallic glasses, heat-resistive polymers.
To satisfy the low cost the optical sensing system should ideally be realizable by a batch process such as is done in the fabrication of MEMS devices.
The power consumption is less than 10 mW, preferably less than 1 mW.
The optical sensing system should be robust and shock-resistant.

1. A smoking device (2) comprising:
a housing having a cavity (200) for at least partially receiving a consumable article (1);
an optical sensing system (5) that is configured to read indicia (10) on a consumable article (1) received in the cavity (200); and
adapting means for adapting a characteristic of the optical sensing system (5) in response to a distance of the indicia (10) from the optical sensing system (5).

2. A smoking device (2) according to claim 1, wherein the optical sensing system (5) comprises an optical element that comprises an optical surface; and wherein the adapting means is configured to adapt a focal length of the optical element by changing a curvature of the optical surface.

3. A smoking device (2) according to claim 2, wherein:
the optical element comprises a body of liquid (122) in contact with a substrate (140), the optical surface being an interface between a surface (130) of the liquid that is not in contact with the substrate (140) and a gas; and
the device further comprises a circuit for applying a potential difference between the liquid and the substrate;
wherein the adapting means is configured to change the curvature of the optical surface by changing the potential difference between the liquid (122) and the substrate (140).

4. A smoking device (2) according to claim 3, wherein the liquid (122) is in contact with a reflective surface (148) of the substrate (140).

5. A smoking device (2) according to claim 4, wherein the reflective surface (148) of the substrate (140) is curved to act as a concave mirror.

6. A smoking device (2) according to claim 2, wherein the optical element comprises a body of liquid, the optical surface being a surface of the liquid; and wherein the adapting means is configured to change the curvature of the optical surface by changing the quantity of liquid in the body.

7. A smoking device (2) according to claim 6, wherein the optical element further comprises a reservoir (152) of liquid coupled to the body of liquid; and a heater (154) controllable to change the temperature of the liquid in the reservoir (154), whereby liquid can be displaced from the reservoir (154) towards the body of liquid by thermal expansion of the liquid in the reservoir (154).

8. A smoking device (2) according to claim 6 or claim 7, wherein the body of liquid is contained within a cell (150) comprising a resilient membrane (156) that defines the optical surface.

9. A smoking device (2) according to claim 1, wherein the adapting means is configured to move at least one optical element (120) of the optical sensing system (5) to maintain the optical element (120) at a predetermined distance from the indicia (10).

10. A smoking device (2) according to claim 9, wherein the optical element (120) is formed in or mounted on a support element (171); and wherein the adapting means is configured to move the optical element (120) relative to the indicia (10) by changing a shape of the support element (171).

11. A smoking device (2) according to claim 9, wherein the optical element (120) is formed in or mounted on a central plate (170) and wherein the distance of the central plate (170) from the indicia (10) is controlled using electric charges.

12. A smoking device (2) according to claim 11, further comprising at least one charge plate (E1, E2, E3, E4) generally parallel to the central plate (170); and means for controlling the electrical charge on the charge plate (E1, E2, E3, E4) in order to attract or repel the central plate 170.

13. A smoking device (2) according to claim 11 or claim 12, wherein the central plate (170) is supported on a resilient support element.

14. A smoking device (2) according to any of claims 9 to 13, wherein the optical element comprises a pinhole (20).

15. A smoking device (2) according to claim 1, wherein the optical sensing system (5) comprises a pinhole (20); and wherein the adapting means is configured to adapt a size of the pinhole (20) in response to a distance of the indicia (10) from the optical sensing system (5).
